(19) United States
(12) Patent Application Publication
(10) Pub. No.: US 2008/0242365 A1
(43) Pub. Date: Oct. 2, 2008

(54) DEVICES AND METHODS FOR HANDS-FREE CONNECTIVITY TO PLURAL DEVICES

(75) Inventors: Daniel S. Rokusek, Long Grove, IL (US); Taneka L. Frazier, Lilburn, GA (US); Kranti K. Kambhampati, Palatine, IL (US); Firas S. Khasawneh, Palatine, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Libertyville, IL (US)

(21) Appl. No.: 11/692,477

(22) Filed: Mar. 28, 2007

(51) Int. Cl. H04B 7/00

(52) U.S. Cl. 455/569.1

(57) ABSTRACT

Disclosed are a hands-free device and a method of a hands-free device for automatic connectivity to two or more handheld devices. Upon power-up of the hands-free device, the device may cycle through all voice communication devices on its paired device list until it either cycles through the entire list or establishes a connection link before reaching the end of the list. It may then cycle through all non-voice communication devices on its paired device list. Once all voice and non-voice communication devices on the paired device list have been paged, the hands-free device may enter an idle mode where it is possible for a user to add a new device to the paired device list. The hands-free device may repeat the cycle through the voice communication devices in the paired device list, at a slower rate than the previous cycle through.

### FIELD

Disclosed are devices and methods for hands-free connectivity, and more particularly a hands-free device and a method of a hands-free device for providing automatic connectivity to two or more handheld devices.

### BACKGROUND

A hands-free device can receive transmitted signals from a handheld device, for example, via Bluetooth, and in turn broadcast the audio signals received from the handheld device. A hands-free device may have, for example, a headset form factor with earphones or may be designed for use during automotive operations with a loudspeaker. For mobile communication devices such as cellular telephones, a hands-free device that can provide hands free operation in a driving situation may be important for both convenience and safety.

Users of mobile communication devices such as cellular telephones may own more than one device that may be configured for communication with a hands-free device. For example, certain music playback devices may include short range transceivers for communication with a hands-free device. A user may wish to connect two or more handheld devices to a hands-free device simultaneously. However, traditionally a hands-free device lacks a hub capability for multi-point connectivity. That is, if two different types of devices are on a paired device list of a hands-free device, the hands-free will initiate communication by paging a voice device or a non-voice device. However, once one connection link is established, the hands-free device cannot automatically connect to another handheld device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts a hands-free device that may be in communication with two different handheld devices;

FIGS. 2A and 2B together depict a flowchart of an embodiment of the described method of a hands-free device;

FIG. 3 illustrates an embodiment of a method for entering the idle mode of FIG. 2A;

FIG. 4 is an embodiment of a method including that, for example, an idle period may provide a user the opportunity to add a new device to the paired device list;

FIG. 5 is a timing diagram illustrating a possible scenario, of course depending upon the number and categories of devices in the paired device list; and

FIG. 6 is another timing diagram illustrating a possible scenario, of course depending upon the number and categories of devices in the paired device list.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

It may be beneficial to connect two or more handheld devices to a hands-free device simultaneously, and moreover to establish such connection automatically. It may also be beneficial to automatically establish connections to multiple handheld devices while giving priority to voice devices. It may further be beneficial to search and find multiple devices and connect to them in a fashion that may help provide a better user experience. In this manner, a hands-free device may continually look for handheld devices (voice, music, navigation, etc.) but with priority given to phone calls and other voice communications.

Disclosed are a hands-free device and a method of operating a hands-free device that may provide automatic connectivity to two or more handheld devices, thus avoiding the need for a user to manually force the connection of a second handheld device to a hands-free device. Accordingly, once the disclosed hands-free device is powered up, the device may cycle through all voice communication devices on its paired device list until it either cycles through the entire list or establishes a connection link before reaching the end of the list. If a connection link to a voice communication device is either made, or not made, it may then cycle through all non-voice communication devices on its paired device list.

Once all voice and non-voice communication devices on the paired device list have been paged, and none respond, the hands-free device may enter an idle mode where it is possible for a user to add a new device to the paired device list. It is understood that a device may also be added to the paired device list when the hands-free device is not in idle mode. It may also be possible to force a connection to a device not yet paged, that is, a device further down the paired device list. It may further be possible to force a connection to a device that earlier was intentionally disconnected but where the user now may want to re-establish a connection to it. In another embodiment, once a connection link to a non-voice communication device is established but a link to a voice communication device has not been established, the hands-free device may enter an idle mode where it is possible for a user to add a new device to the paired device list. If after the idle mode there is still no voice communication device connection link, the hands-free device may repeat the cycle through the voice communication devices in the paired device list, but at a slower rate than the previous cycle through.

The disclosed hands-free device and a method of operating a hands-free device may provide a hub capability for multi-point connectivity. A voice communication device may be, for example, a cellular telephone. A non-voice communication device may be, for example, a music playback device or a data device such as a navigation device. In this way, connectivity to a voice communication device may be given priority and a secondary connection to a non-voice handheld device such as a music playback device may be quickly and automatically established as well.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

At least some inventive functionality and inventive principles may be implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

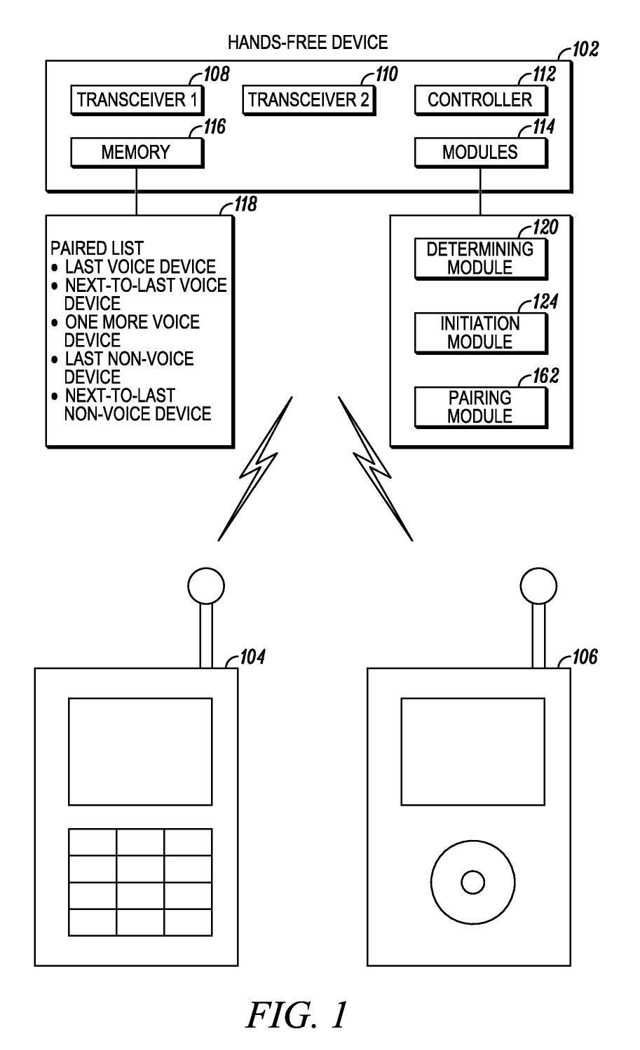

FIG. 1 depicts a hands-free device 102 that may be in communication with two or more different handheld devices 104 and 106. The handheld device 104 is depicted as a mobile communication device and the handheld device 106 is depicted as a music playback device. Both may be enabled for short range communication, via for example a Bluetooth protocol. It is understood that any type of short range communication is within the scope of this discussion.

The hands-free device may be, for example, a headset or a car kit. It is understood that the hands-free device may include any suitable form factor and that it may be configured to maintain connection links with at least two devices. The mobile communication device 104 may be for example, a cellular telephone (also called a mobile phone). The mobile communication device 104 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP). The second handheld device 106, depicted as a music playback device, of course may be any type of handheld device, including, for example, a navigation device.

The hands-free device 102 is depicted with one or more transceivers. Transceiver 108 and transceiver 110 may provide short range connection links with the handheld devices 104 and 106. It is understood that one Bluetooth transceiver may connect to up to 7 other Bluetooth devices. Transceiver 108 and transceiver 110 may instead or in addition enable different short range wireless systems, for example, Bluetooth for one transceiver and Ultra Wideband (UWB) for the other transceiver, in order to connect to devices supporting these different systems. In another embodiment, the second transceiver may enable WiFi capability. A controller 112 may be coupled to the transceivers 104 and/or 106, and may be coupled to modules 114. The modules 114 may include for example, a determining module 120, an initiation module 124 and a pairing module 162, which will be discussed in more detail below. The modules can carry out certain processes of the methods as described herein. Steps of methods may involve modules and modules may be inferred by the methods discussed herein. The modules can be implemented in software, such as in the form of one or more sets of prestored instructions, and/or in hardware, which can facilitate the operation of the mobile station or electronic device as discussed below. The modules may be installed at the factory or can be installed after distribution by, for example, a downloading operation. The operations in accordance with the modules will be discussed in more detail below.

A memory 116 may hold a paired device list 118. The paired device list 118 may be established at any time prior to initiating the presently described method. Processes for establishing a paired device is are often included with instructions of the device. Depending upon the configuration of the hands-free device, the paired device list may include a certain number of devices, for example, eight. For example, the paired devices in the paired device list may be categorized into different categories. In one embodiment, the paired device list may contain voice communication devices, non-voice communication devices and data communication devices.

In this discussion, the paired device list 118 may be described as including devices of two different categories. Devices may be categorized as either voice communication devices or non-voice communication devices. The list may contain for example, a last connected voice device, a next-to-last connected voice device, one more voice device, a last connected non-voice device and a next-to-last connected non-voice device. In such an embodiment, a paired device list may contain five entries. It is understood that the devices listed in the paired device may be sorted in the list according to time since last connection. That is, for example, the most recently connected device may be listed first, and the least recently connected device may be listed last.

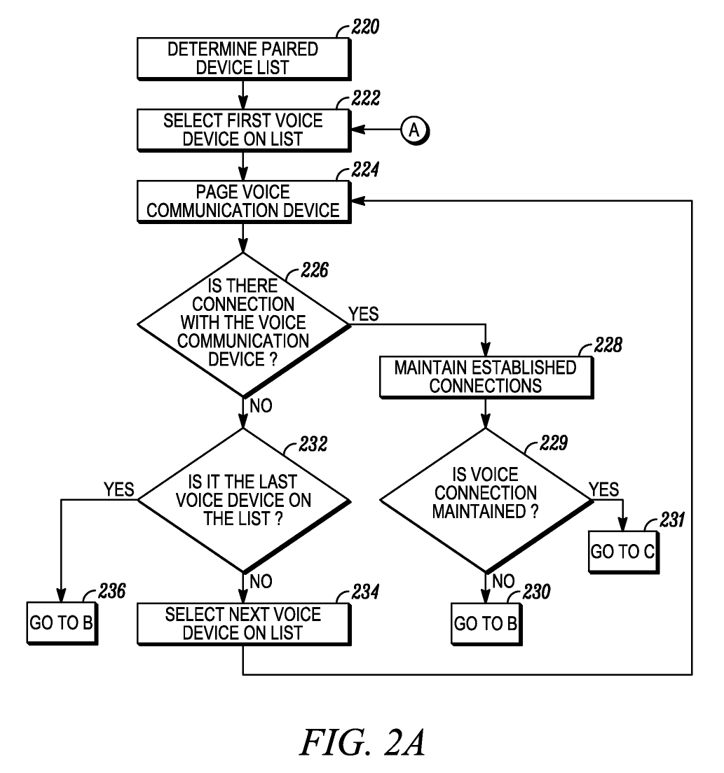

FIGS. 2A and 2B together depict a flowchart of an embodiment of the described method of a hands-free device. An embodiment of the method may include determining a paired device list 220 that may include at least one voice communication device and may include at least one non-voice communication device. An example paired device list 118 (see FIG. 1) is discussed above. A determining module 120 may operate to access the paired device list. The method may include selecting 222 the first voice communication device on the paired device list 118. In this manner the last-connected voice communication device of the paired device list 118 may be selected.

The method may further include initiating short-range communication by a short range transceiver such as transceiver 108 (see FIG. 1) by paging 224 for the voice communication device. As an example, device 104 may be the last-connected voice communication device of the paired device list 118. An initiation module 124 may operate to initiate paging. Following paging 224, a query may be made 226 whether a connection is made with the voice communication device, that is, whether the paging for the voice communication device is acknowledged.

If the answer to the query 226 is yes, the connection is maintained 228. Any other connections that may have been established by the device may also be maintained 228. A further query may be made 229 whether the voice connection is maintained. If the answer is no, the method may then continue 230 with the non-voice communication devices on the paired device list 118 (see FIG. 1) including an idle mode 238. If the answer is yes, the method may then continue 231 with the non-voice communication devices on the paired device list 118 without including an idle mode 238.

If the answer to the query 226 is no, a query may be made 232 whether the voice communication device was the last voice device on the paired device list 118 (see FIG. 1). If the answer is no, the next voice communication device on the paired device list 118 may be selected 234, and the method may return to step 224 to page that device. It is understood that since the devices on the paired device list 118 are sorted in increasing order of time since last connection, the next-to-last connected voice communication device may follow the last-connected voice communication device in processing the paired device list 118. Cycling through a portion of the method may continue until the last voice communication device on the list has been paged and no connection has been made. In such a case, the answer to the query 232 may be yes, and the method may continue 236 with the non-voice devices of the paired device list 118.

An idle mode 238 that will be discussed in more detail below may be entered for a predetermined period of time after the voice devices in the paired device list 118 (see FIG. 1) have been cycled through, and prior to processing the non-voice communication devices of the paired device list 118. After expiration of a predetermined idle time 238, the first non-voice communication device on the paired device list 118 may be selected 240. In this manner, since the devices on the paired device list are sorted in order of increasing time since last connection, the last-connected non-voice communication device of the paired device list 118 may be selected. Accordingly, the next-to-last connected non-voice communication device may follow the last-connected non-voice communication device in processing the paired device list 118.

The method may further include initiating short-range communication by a short range transceiver such as transceiver 108 (see FIG. 1) by paging 241 for the non-voice communication device. As an example, device 106 may be the last-connected non-voice communication device of the paired device list 118. Following paging 241, a query may be made 242 whether a connection is made with the non-voice communication device, that is, whether the paging for the non-voice communication device is acknowledged.

If the answer to the query 242 is yes, the established connections are maintained 243. That is, the connections that may have been established by the hands-free device 102 (see FIG. 1) may also be maintained 243 as well as the just established connection to the non-voice communication device. When the established connections are maintained 243 the system may be in a connected mode.

If the answer to the query 242 is no, (i.e. unacknowledged) a query may be made 246 whether the non-voice communication device was the last non-voice device on the paired device list 118 (see FIG. 1). If the answer is no, the next non-voice communication device on the paired device list 118 may be selected 247, and the method may return to step 241 to page that device. Cycling through a non-voice portion of the method may continue until the last non-voice communication device on the paired device list 118 has been paged and no connection has been made. In such a case, the answer to the query 246 may be yes, and the method may enter idle mode 248 for a predetermined period of time before returning 249 to cycling through the voice devices of the paired device list 118.

FIGS. 2A and 2B depict an embodiment of the method which returns to searching for voice devices after finding the last connected voice device but not finding the last connected non-voice device (after the idle mode). It is understood that the system may continue to search for non-voice devices (if any were paired). In another embodiment, all voice devices may be connected first and then multiple non-voice devices (for Bluetooth, up to 8 separate devices) may be connected.

In an idle mode 238 and 248, a user may be given the opportunity to add a device to the paired device list 118. For example, a user may have a new communication device that is not in the paired device list 118 (see FIG. 1). The user may follow instructions to add the device to the paired device list 118. It is understood that a user can add a device to the paired device list 118 at any time, not only during an idle mode period. Moreover, if the device was previously paired then the device can connect during an idle mode.

It is understood that the embodiment of a method of FIGS. 2A and 2B is non-inclusive of all possible method configurations and scenarios involving the number of devices in the paired device list 118 (see FIG. 1) and the number of categories in the paired device list 118. For example, the hands-free device 102 may be placed into idle mode after cycling through all voice devices in the paired device list 118 and/or after cycling through all devices in the paired device list 118. The disclosed hands-free device 102 and a method of a hands-free device 102 may provide a hub capability for multi-point connectivity. In accordance with the described method, connectivity to a voice communication device may be given priority and a secondary connection to a non-voice handheld device such as a music playback device may be quickly and automatically established as well.

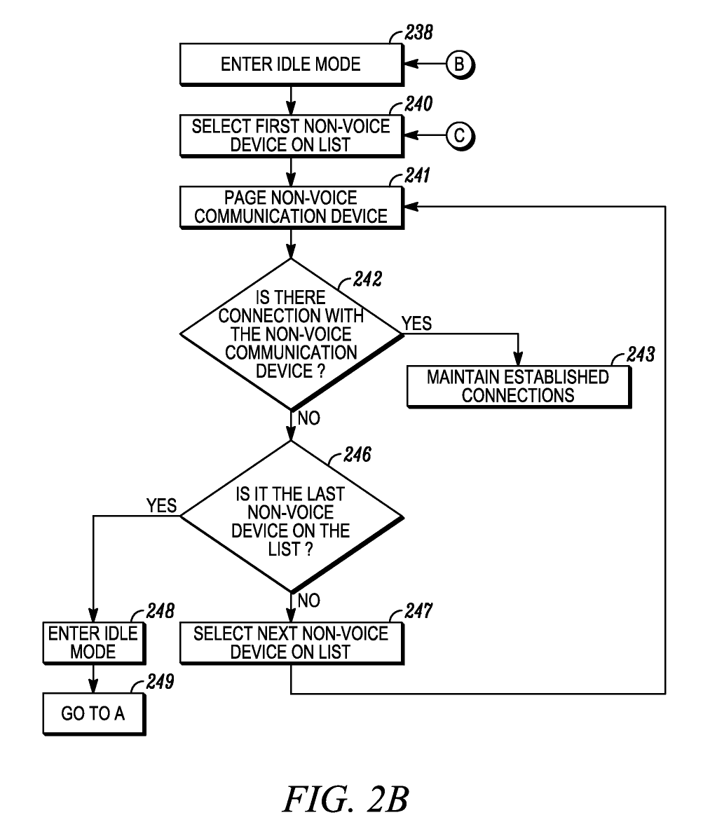

FIG. 3 illustrates an embodiment of a method for entering the idle mode 238 (see FIG. 2B). In this embodiment, the hands-free device 102 (see FIG. 1) can cycle through 350 the voice communication devices and the non-voice communication devices of the paired device list 118, at a first predetermined rate. Assuming that there are no connection links established between the hands-free device and a voice communication device, a query will determine 352 whether there is a connection link established between the hands-free device and a non-voice device. If yes, an idle period 338 will be established. After the idle period ends, if no new voice communication devices are paired with the hands-free device, the method may include cycling through the voice communication devices in the paired device list 118, but at a second predetermined rate 354. The first rate may be, for example, 15 seconds between initiations. The second rate may be, for example 10 seconds between initiations of paging for voice communication devices. In another embodiment the second rate may be the same rate as the first rate. In yet another embodiment the second rate may be approximately between 10 seconds and 15 seconds between initiations of paging for voice communication devices. Each rate may be predetermined by a plurality of factors. The factors may include for example, settings for power savings, expected user behavior patterns, and types of voice communication devices and/or non-voice communication devices connected.

Since in the above described example at step 352, the non-voice communication device has a connection link established with the hands-free device 102 (see FIG. 1), there may be audio data or other data being processed by the hands-free device. If a user were for example listening to music, a more frequent paging according to a first predetermined rate may be perceptible by a user. Accordingly, it may be beneficial to page for a voice communication device with less frequent paging according to a second slower second predetermined rate as any interruptions may be less perceptible by a user at a slower rate.

Returning to the query as to whether any connection link is established 352 with a non-voice device and assuming that there are no connection links established between the hands-free device and a voice communication device, the hands-free device may be placed in idle mode 356 to give the user an opportunity to pair a new device to the hands-free device. If there is no new device paired, then the method may return to cycling through all voice and non-voice devices at the first predetermined rate 350.

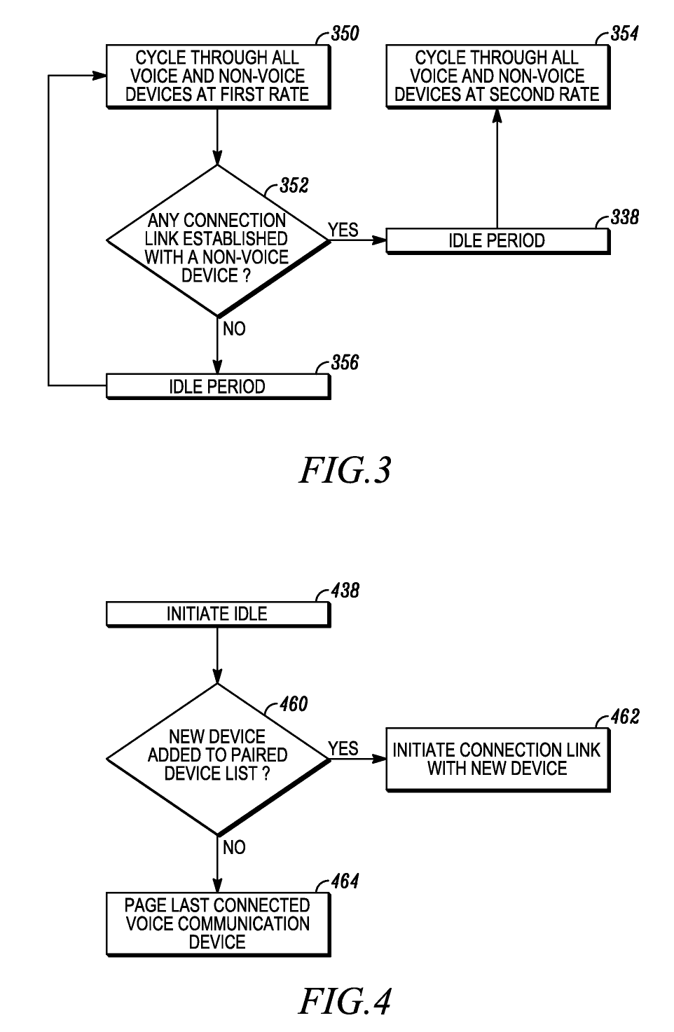

FIG. 4 is an embodiment of a method including that, for example, an idle period 438 may provide a user the opportunity to add a new device to the paired device list 118 (see FIG. 1). A query may determine 460 whether a new device has been added to the paired device list 118. Pairing may be established by pairing module 162. If yes, a connection link between the hands-free device and the new device may be established 462. If no, the method may include initiating paging of last-connected voice or non-voice communication devices 464 as described with reference to FIGS. 2A and 2B.

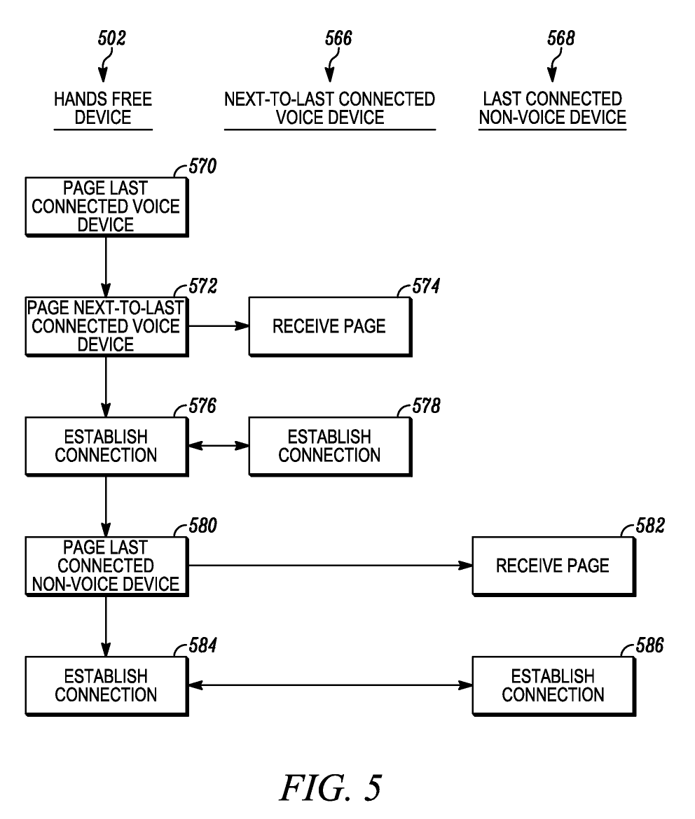

FIG. 5 is a timing diagram illustrating a possible scenario, of course depending upon the number and categories of devices in the paired device list 118 (see FIG. 1). The hands-free device 502, the next-to-last-connected voice communication device 566, and a last-connected non-voice communication device 568 may be present and powered up. The hands-free device 502 may first page 570 a last connected voice device however, there may be no response. The hands-free device 502 may then page 572 a next-to-last connected voice communication device 566 which may respond 574. A connection link 576 between the devices 578 may be established. In this way, connectivity to a voice communication device may be given priority. The hands-free device 502 may then page 580 a last-connected non-voice communication device 568 which may respond 582. A connection link 584 between the devices 586 may be established. In this way, a secondary connection to a non-voice handheld device such as a music playback device may be quickly and automatically established as well.

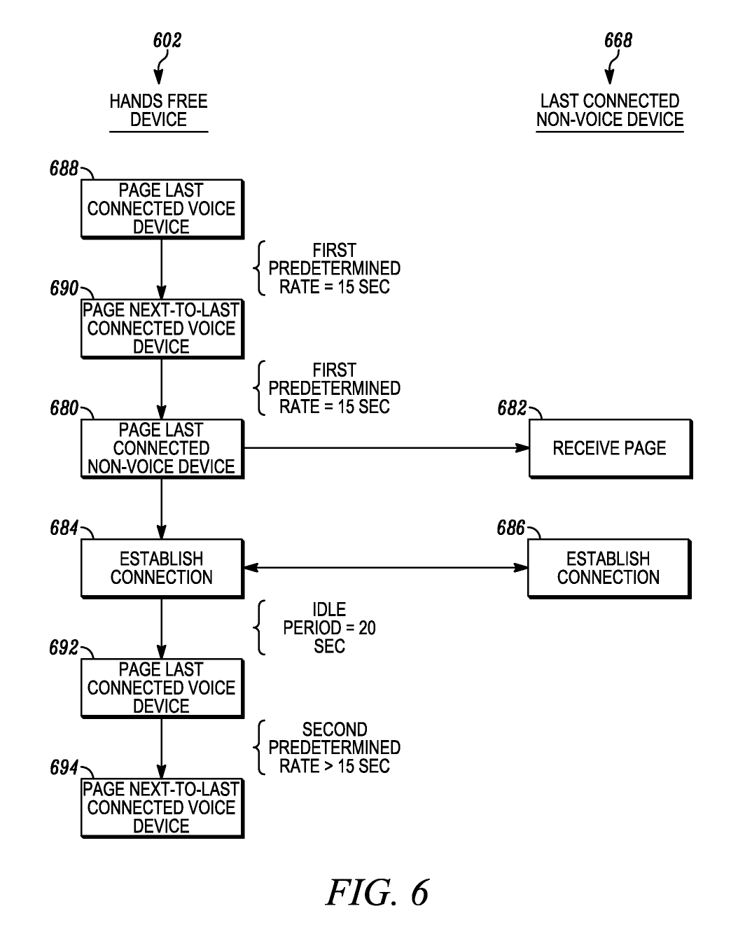

FIG. 6 is another timing diagram illustrating a possible scenario, of course depending upon the number and categories of devices in the paired device list 118 (see FIG. 1). The hands-free device 602 and a last-connected non-voice communication device 668 may be present and powered up. The hands-free device 602 may first page 688 a last connected voice device however, there may be no response. The hands-free device 602 may then page 690 a next-to-last connected voice device however, there may be no response. The hands-free device 602 may then page 680 a last connected non-voice communication device 668 which may respond 682.

The paging of the devices 688, 690 and 680 may be at a first predetermined rate, in this example, 15 seconds. A connection link 684 and 686 between the hands-free device 602 and the last-connected non-voice communication device 668 may be established. Since no connection link was established with a voice communication device, the method may include an idle period 438 (see FIG. 4) that may be approximately 20 seconds to give a user an opportunity to add a device to the paired device list 118 (see FIG. 1).

The paging of the voice communication devices on the paired list may be continued by paging the last-connected voice communication device 692 and by paging the next-to-last-connected voice communication device 694 at a second predetermined rate that is slower that the first predetermined rate. As discussed above, the first rate and the second rate may be different. Since in this example, the non-voice communication device has a connection link established with the hands-free device 102, and there may be audio data such as music or other data being processed by the hands-free device, more frequent paging according to a first predetermined rate may be perceptible by a user, whereas less frequent paging according a second slower second predetermined rate may be less perceptible by a user.

In the event that a user wishes to disconnect a specific connected device or service, the user may manually disconnect the device from the device side. Therefore, the user may have the option of enabling/disabling certain services. For example, if a mobile communication device supports both Hands Free Profile (HFP) and music, then the user may elect to disable HFP or music, or both depending on the user interface of the device.

In one embodiment, while the system is paging a device on the paired device list 118 (see FIG. 1), any connection attempt from such a device may not be processed. The system of the hands-free device 102 may be kept in connectable mode that is, cycling through first the voice communication devices and then other types of devices, since there may be certain intermediate delays when the system is looping through the devices on the paired device list 118 and if the incoming connection falls into this window then the connection can go through.

Multi-point connectivity may be supported. That is, for example if available, one HFP1.5 service and one Advanced Audio Distribution Profile (A2DP)/Audio/Video Remote Control Profile (AVRCP) service may be simultaneously supported. Accordingly, either one or two devices may be connected. For example, if a voice communication device supports HFP1.5 and A2DP/AVRCP then it may be the only connected device. If the voice communication device does not support A2DP/AVRCP, then a non-voice communication device such as a music playback device may also be connected. A hands-free device 102 (see FIG. 1) may also provide scatternet capability in the case where Master/Slave role switches are not supported in the connected communication devices.

The disclosed hands-free device and a method of a hands-free device may provide a hub capability for multi-point connectivity. A voice communication device may be, for example, a cellular telephone. A non-voice communication device may be, for example, a music playback device or a data device such as a navigation device. In this way, connectivity to a voice communication device may be given priority and a secondary connection to a non-voice handheld device such as a music playback device may be quickly and automatically connected as well.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method of a hands-free device, comprising:
determining a paired device list that includes at least one voice communication device and at least one non-voice communication device;
initiating short-range communication by paging for a first voice communication device that is the last-connected voice communication device of the paired device list;
initiating short-range communication by paging for a second voice communication device that is the next to the last-connected voice communication device of the paired device list in response to the paired device list containing two voice communication devices and in response to the unacknowledged paging for the first voice communication device;
initiating short-range communication by a paging for a first non-voice communication device that is the last-connected non-voice communication device of the paired device list;
wherein a rate at which paging for the first voice communication device is followed by at least one of the paging for the second voice communication device or the paging for a non-voice communication device is at a first predetermined rate.

2. The method of claim 1, further comprising:
discontinuing initiating short-range communication for an idle period after all voice communication devices of the paired device list have been paged.

3. The method of claim 2, wherein the idle period is approximately 20 seconds.

4. The method of claim 2, further comprising:
adding a new voice communication device to the paired device list during the idle period.

5. The method of claim 1, further comprising:
continuing initiating short-range communication by intermittent paging of at least one voice communication device of the paired device list at a second predetermined rate in response to a previously unacknowledged paging of a voice communication device of the paired device list and in response to an acknowledged paging of a non-voice communication device.

6. The method of claim 1, wherein initiating short-range communication by paging for a first non-voice communication device occurs after paging for all voice communication devices of the paired device list was unacknowledged.

7. The method of claim 1 wherein the first predetermined rate is 15 seconds between pages.

8. The method of claim 5 wherein the second predetermined rate is approximately between 10 seconds and 15 seconds between pages.

9. The method of claim 1 wherein the first predetermined rate is faster than the second predetermined rate.

10. The method of claim 1, wherein the voice communication device is a cellular telephone.

11. The method of claim 1, wherein the non-voice communication device is a music playback device.

12. The method of claim 1, wherein the non-voice communication device is a navigation system device.

13. A hands-free device, comprising:
a short-range transceiver for short-range communication;
a controller coupled to the short-range transceiver;
a determining module coupled to the controller and configured to determine a paired device list that includes at least one voice communication device and at least one non-voice communication device;
an initiating module coupled to the controller and configured to:
initiate short-range communication by paging a first voice communication device that is the last-connected voice communication device of the paired device list;
initiate short-range communication by paging a second communication voice device that is the next to the last-connected voice communication device of the paired device list if the paired device list contains two voice communication devices and if initiation of short-range communication with the first voice communication device fails; and
initiate short-range communication by paging a first non-voice communication device that is the last-connected non-voice communication device of the paired device list;
wherein:
a rate at which paging for the first voice communication device is followed by at least one of the paging for the second voice communication device or the paging for a non-voice communication device is at a first predetermined rate.

14. The device of claim 13, wherein the initiating module is further configured to discontinue initiating short-range communication for an idle period after all voice communication devices of the paired device list have been paged.

15. The device of claim 14, further comprising:
a pairing module coupled to the controller and configured to add a new voice communication device to the paired device list during the idle period.

16. The device of claim 13, wherein the initiating module is further configured to:
continue initiating short-range communication by intermittent paging of at least one voice communication device of the paired device list at a second predetermined rate if paging of a voice communication device of the paired device list was previously unacknowledged and if the paging of a non-voice communication device was acknowledged.

17. The device of claim 13, wherein the short-range transceiver is one of a Bluetooth transceiver and a WiFi transceiver.

18. A method of a hands-free device, comprising:
determining a paired device list that includes at least one voice communication device and at least one non-voice communication device;
initiating short-range communication by paging for a first voice communication device that is the last-connected voice communication device of the paired device list;
initiating short-range communication by paging for a second voice communication device that is the next to the last-connected voice communication device of the paired device list in response to the paired device list containing two voice communication devices and in response to the unacknowledged paging for the first voice communication device;
initiating short-range communication by a paging for a first non-voice communication device that is the last-connected non-voice communication device of the paired device list;
discontinuing initiating short-range communication for an idle period after all voice communication devices of the paired device list have been paged.

19. The method of claim 18, wherein discontinuing initiating short-range communication is at least one of automatic or manual.

20. The method of claim 19, further comprising:
adding a new voice communication device to the paired device list during the idle period.
